(19) United States
(12) Patent Application Publication
(10) Pub. No.: US 2018/0107253 A1
(43) Pub. Date: Apr. 19, 2018

(54) TABLET COMPUTER CASE WITH DUAL-HINGE SUSPENSION

(71) Applicant: Nvidia Corporation, Santa Clara, CA (US)

(72) Inventor: Boris Landwehr, Thousand Oaks, CA (US)

(21) Appl. No.: 15/295,795

(22) Filed: Oct. 17, 2016

(51) Int. Cl. G06F 1/16

(52) U.S. Cl. CPC G06F 1/1681; G06F 1/1616

(57) ABSTRACT

A tablet computer and keyboard are coupled to a tablet computer case. The tablet computer case includes a dual-hinge suspension that allows the tablet computer case to open and close with similar mechanics as a laptop computer. In particular, the dual-hinge suspension includes two hinges that open and close sequentially in different phases. During a first phase of opening, the first hinge opens until a mechanical limit is reached while the second hinge remains stationary. In a second phase of opening, the first hinge is stationary while the second hinge opens until a mechanical limit is reached. During a first phase of closing, the second hinge closes until a mechanical limit is reached while the first hinge remains stationary. In a second phase of closing, the second hinge is stationary while the first hinge closes until a mechanical limit is reached.

### BACKGROUND OF THE INVENTION

### Field of the Invention

Embodiments of the present invention relate generally to tablet computer accessories, and, more particularly, to a tablet computer case with dual-hinge suspension.

### Description of the Related Art

A conventional tablet computer generally has a monolithic form factor that does not include a dedicated keyboard or track pad. Accordingly, peripheral keyboards, some of which include track pads, are popular accessories amongst tablet owners. When used in conjunction with a peripheral keyboard, a tablet computer may provide certain advantages over conventional laptop computers. For example, tablet computers generally have longer battery life compared to laptop computers. Furthermore, tablet computers are typically lighter than laptop computers.

In order to provide an overall user experience similar to the user experience associated with a laptop computer, a customized suspension is typically implemented in order to physically support one or both of the tablet computer and the peripheral keyboard. Accordingly, many manufacturers now produce tablet computer cases that include a suspension for performing this purpose. Such tablet cases also typically include a docking area to which a keyboard can be coupled.

One drawback of conventional tablet computer case designs is that those designs typically require various design compromises to be made that prevent tablet computers from delivering user experiences similar to what laptop computers typically deliver. For example, some tablet cases are able to support a tablet computer in an upright configuration via a kickstand suspension. A peripheral keyboard can then be coupled to the tablet. However, this configuration is generally inferior to the laptop experience because the tablet, kickstand, and keyboard need to be placed on a flat surface, such as a table, and cannot be comfortably used on a person's lap.

Other types of tablet cases can be folded into triangular shapes to provide support for a tablet computer. A keyboard can then be coupled beneath the edge of the tablet. However, in such a configuration, the center of gravity of the tablet lies behind the triangular support. Consequently, the tablet computer is prone to falling over. Further, the triangular shape of the tablet case can be challenging to fold, further complicating the user experience. Finally, such designs typically lack a track pad, a requisite feature for conventional laptop computers.

Yet other types of tablet cases include a full size keyboard and a track pad coupled to a backing area to which only certain types of tablets can be coupled. Specifically, only tablets with smaller, lighter weight batteries can be used with these types of cases to prevent the tablet from toppling over. However, with smaller batteries, such tablets can only be used for four hours or less, unlike a traditional tablet.

As the foregoing illustrates, what is needed in the art is a tablet case design that is able to provide a user experience that is similar to what a laptop computer can provide.

### SUMMARY OF THE INVENTION

One embodiment of the present invention sets forth a tablet computer case, comprising a first surface configured to couple to a keyboard, a second surface configured to couple to a tablet computer, and a dual-hinge suspension coupled between the first surface and the second surface. The dual-hinge suspension comprises a first hinge coupled to the first surface, and a second hinge coupled to the second surface, where the first hinge operates in response to a mechanical limit associated with the second hinge and the second hinge operates in response to a mechanical limit associated with the first hinge.

At least one advantage of the disclosed technique is that the tablet computer provides a user experience that is substantially similar to the user experience associated with a traditional laptop computer without making significant design comprises.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective schematic diagram of a tablet computer case that includes a dual-hinge suspension, according to various embodiments of the invention;

FIG. 2 illustrates the tablet computer case of FIG. 1 in a closed configuration, according to various embodiments of the invention;

FIG. 3 illustrates the tablet computer case of FIG. 1 during a first phase of opening, according to various embodiments of the invention;

FIG. 4 illustrates the tablet computer case of FIG. 1 during a second phase of opening, according to various embodiments of the invention;

FIG. 5 illustrates the tablet computer case of FIG. 1 during a first phase of closing, according to various embodiments of the invention;

FIG. 6 illustrates the tablet computer case of FIG. 1 during a second phase of closing, according to various embodiments of the present invention; and

FIGS. 7A-7B illustrate a flow diagram of method steps for opening and closing a tablet computer case, according to various embodiments of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

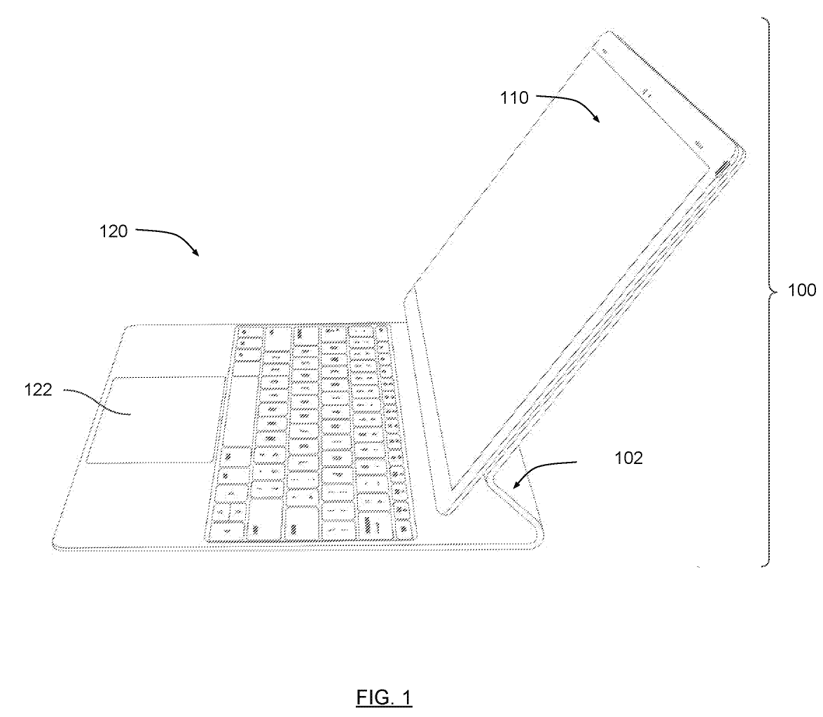

FIG. 1 is a perspective schematic diagram of a tablet computer case that includes a dual-hinge suspension, according to various embodiments of the invention. As shown, tablet computer case 100 is coupled to a tablet computer 110 and to a keyboard 120. Keyboard 120 includes a track pad 122. Tablet computer case 100 includes a dual-hinge suspension 102.

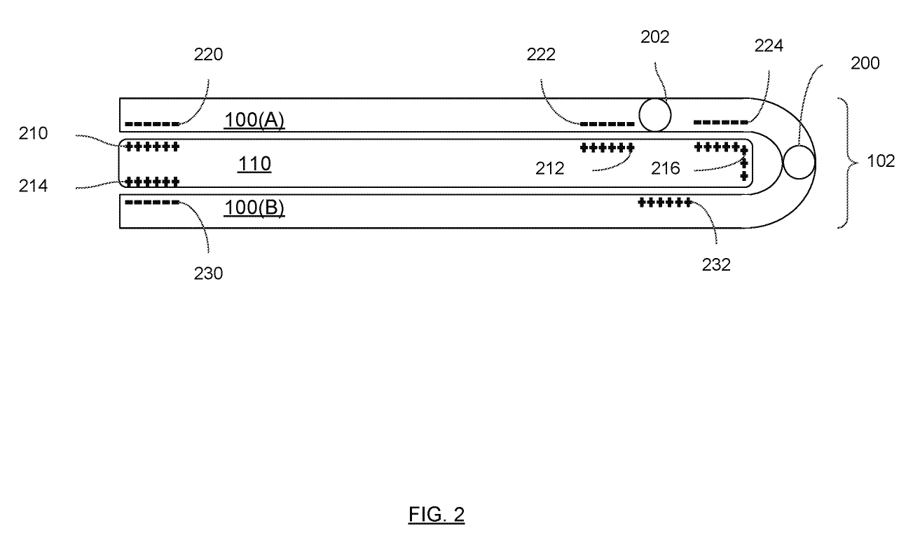

Tablet computer 110 may be any technically feasible form of computing device that generally has a tablet form factor. Tablet computer 110 may be coupled to tablet computer case 100 via any technically feasible coupling mechanism. However, in various embodiments, tablet computer 110 is coupled to tablet computer case 100 via one or more magnets, as described below in conjunction with FIGS. 2-6.

Keyboard 120 may be any technically feasible type of keyboard, including, for example, a full-size keyboard. Likewise, track pad 122 may be any technically feasible type of touch-enabled device for controlling a cursor on the screen of tablet 110. Keyboard 120 may be coupled to tablet computer case 100 via one or more magnets, similar to the coupling mechanism associated with tablet computer 110 mentioned above. Alternatively, keyboard 120 may be integrated into tablet computer case 100.

Tablet computer 110 and keyboard 120 may be coupled together via one or more physical wires or coupled together wirelessly. In one embodiment, tablet computer 110 provides power to or draws power from keyboard 120 via a connector that is integrated into tablet computer case 100. Tablet computer 110 and keyboard 120 may also perform input/output operations with one another via the connector. In another embodiment, tablet computer 110 provides power to batteries within keyboard 120 via wireless charging coils, and performs input/output operations with keyboard 120 via a wired or wireless communications protocol. In yet another embodiment, keyboard 120 provides power to batteries within tablet computer 110 via wireless charging coils and performs input/output operations with tablet computer 110 via a wireless communications protocol. Persons skilled in the art will recognize that any technically feasible combination of the above embodiments fall within the scope of the invention.

Dual-hinge suspension 102 is a mechanical assembly of hinges configured to allow tablet computer case 110 to open and close similar to how a traditional laptop computer opens and closes. Additionally, dual-hinge suspension 102 is configured to position tablet computer 110 relative to keyboard 120 to achieve a particular balance that is substantially similar to how a traditional laptop computer is balanced. More specifically, dual-hinge suspension 102 positions the center of gravity of tablet computer case 100 (including tablet computer 110 and keyboard 120) at a location that is substantially similar to the center of gravity associated with a traditional laptop computer.

In one embodiment, dual-hinge suspension 102 places the center of gravity of tablet computer case 100 at a position that is between the edges of the bottom side of tablet computer case 100. In this embodiment, the positioning of the center of gravity of tablet computer case 100 is well-suited to promote stability, as opposed to conventional tablet computer cases that place the center of gravity behind the back edge of the bottom surface of the case.

In this manner, tablet computer case 100 may provide a similar user experience to a traditional laptop computer and, yet, also confer certain benefits associated with tablet computers. In particular, tablet computer case 100 is capable of being placed on any type of surface, including the lap of a user, without causing significant instability. In addition, tablet computer case 100 opens and closes in a simple laptop-like manner and includes a full keyboard and track pad, similar to a laptop computer. Further, tablet computer case 100 has a low risk of falling over due to the position of the center of gravity, as described above. Importantly, the tablet computer 110 does not need to compromise battery life to promote stability, as with conventional designs, because dual-hinge suspension 102 provides that stability without needing to change battery size or location. Finally, tablet computer 110 can be removed from tablet computer case 100 with ease, thereby allowing a user to operate tablet computer 110 as a standalone tablet. These and other advantages may be enabled by the dual-hinge suspension 102 described herein. FIGS. 2-6, described in greater detail below, illustrate the operation (e.g., opening and closing) of tablet computer case 100 via dual-hinge suspension 102.

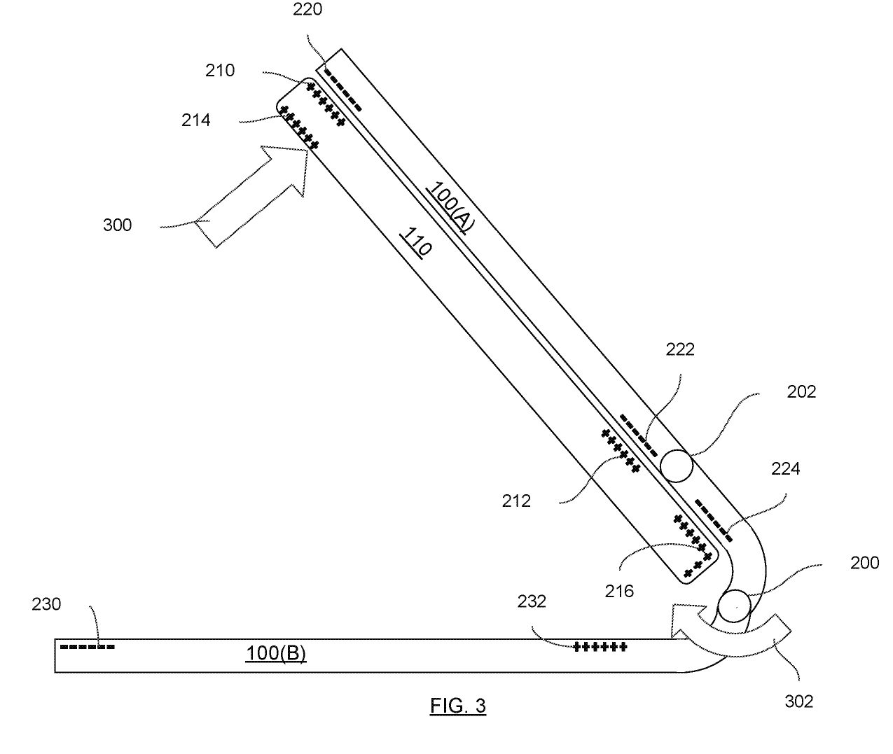

FIG. 2 illustrates the tablet computer case of FIG. 1 in a closed configuration, according to various embodiments of the invention. As shown, tablet computer case 100 includes a top side 100(A) and a bottom side 100(B). Tablet computer 110 is sandwiched between these two sides when tablet computer case 100 is closed. For clarity, keyboard 120 is not shown here or in FIGS. 3-6. However, as mentioned above, keyboard 120 may be coupled to or integrated with tablet computer case 100. As also shown, dual-hinge suspension 102 includes hinges 200 and 202. These two hinges are configured to open and close sequentially, as described in greater detail below in conjunction with FIGS. 3-6.

Tablet computer 110 includes magnet strips 210, 212, 214, and 216, shown here as having a positive polarity facing the tablet computer case 100. Top side 100(A) of tablet computer case 100 includes magnetic strips 220, 222, and 224, and bottom side 100(B) of tablet computer case 100 includes magnet strips 230 and 232, all shown as having a negative polarity facing the tablet computer 110. Persons skilled in the art will understand that magnets in general have both positive and negative polarity, but the polarity of the various magnetic strips shown merely represents the specific polarity dominant at an adjacent surface. Further, persons skilled in the art will recognize that the actual positive and negative polarities shown may be reversed without affecting the attraction and repulsion between neighboring magnet strips.

Tablet computer 110 is coupled to tablet computer case 100 via attraction between magnet strips 210 and 220 and attraction between magnet strips 212 and 222. In addition, tablet computer case 100 may be secured in a closed position via the attraction between magnet strips 214 and 230. When tablet computer case 100 is opened, as described below in conjunction with FIG. 3, magnet strips 214 and 230 may separate from one another, while tablet computer 110 remains coupled to tablet computer case 100 via magnet strips 210 and 220, and 212 and 222.

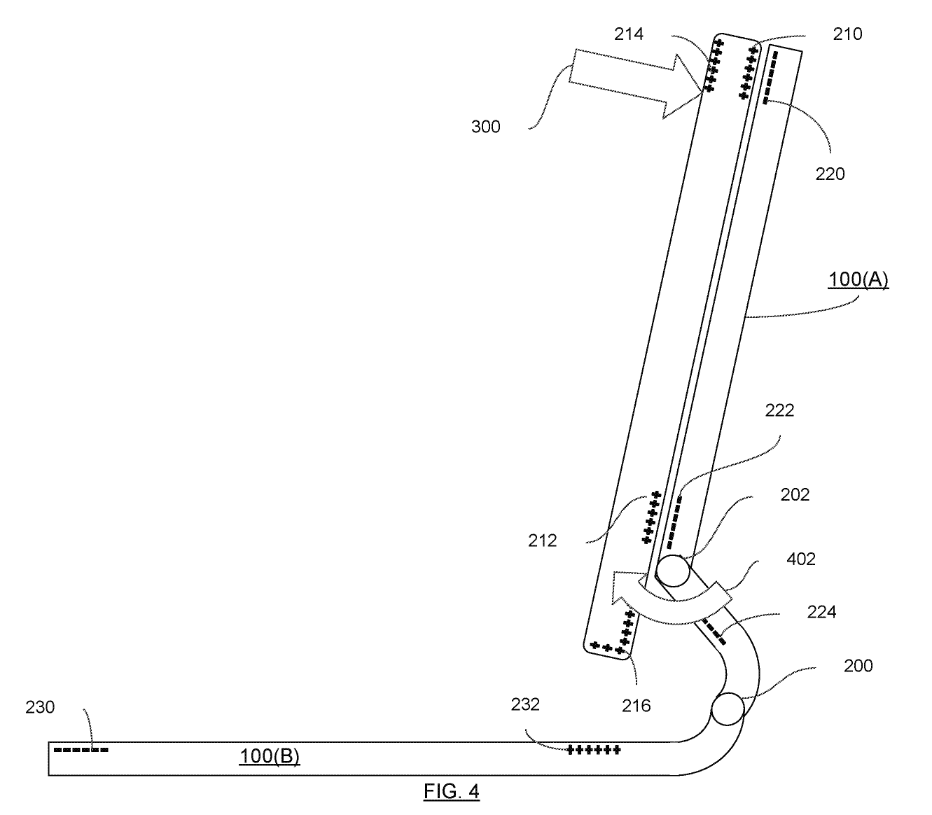

FIG. 3 illustrates the tablet computer case of FIG. 2 during a first phase of opening, according to various embodiments of the invention. In this first phase of opening, only hinge 200 opens. As shown, tablet computer case 100 opens in response to a force 300. Generally, a user opens tablet computer case 100 by exerting force 300. In order for tablet computer case 100 to open in this manner, force 300 exceeds the attractive force between magnets 214 and 230. Additionally, torque 302, induced by force 300, exceeds any counter torque exerted by hinge 200. Importantly, in various embodiments, hinge 202 does not open during the first phase of opening, because any torque induced by force 300 at hinge 202 does not exceed a counter torque induced at hinge 202 by the attraction between magnet strips 216 and 224. In the configuration shown, hinge 200 causes top surface 100(A) and bottom surface 100(B) to form an acute angle relative to one another. Thus, hinge 200 may be said to open to an acute angle. When hinge 200 reaches a maximum open position corresponding to a mechanical limit, the torque induced at hinge 202 increases, and hinge 202 then opens, as described below in conjunction with FIG. 4.

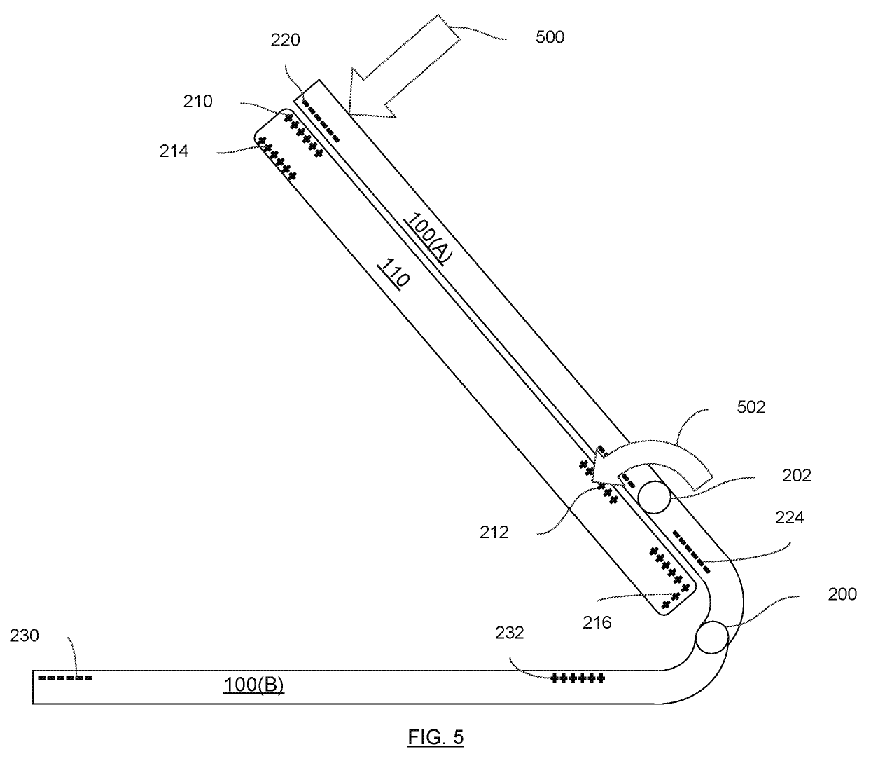

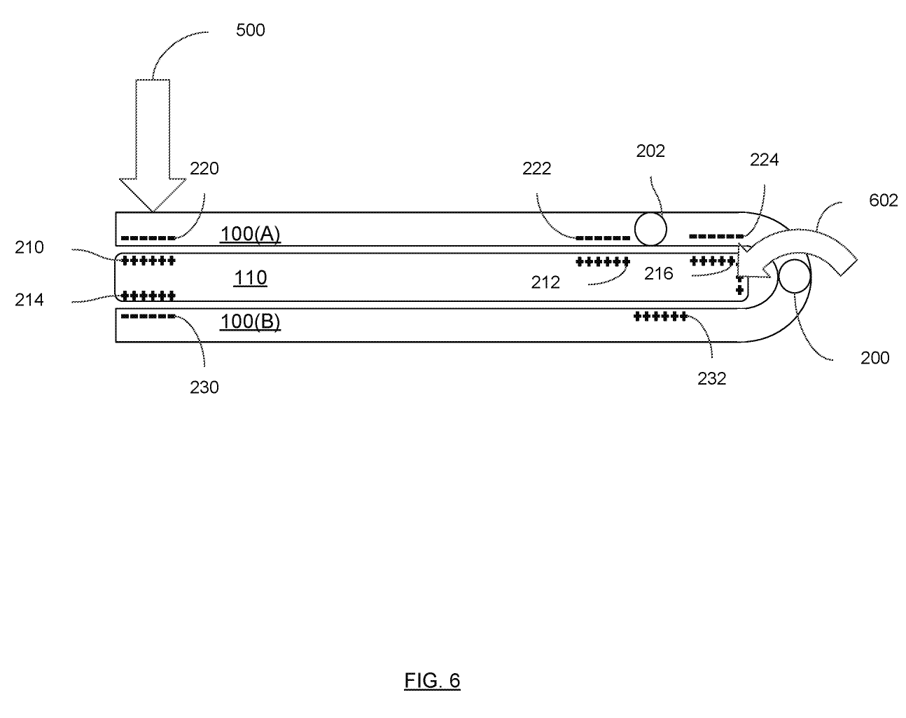

FIG. 4 illustrates the tablet computer case of FIG. 3 during a second phase of opening, according to various embodiments of the invention. In this second phase of opening, only hinge 202 opens. Hinge 200 remains at a maximum open angle associated with the mechanical limit mentioned above. As also mentioned above, when hinge 200 stops opening, a torque 402 is induced by force 300 at hinge 202 that overcomes the attraction between magnet strips 216 and 224 and causes hinge 202 to open. Hinge 202 may open until reaching a maximum open position associated with a mechanical limit. In this configuration, hinge 202 causes top surface 100(A) and bottom surface 100(B) to form an obtuse angle relative to one another. Thus, hinge 202 may be said to open to an obtuse angle. In this manner, tablet computer 110 can be positioned for use. A user may reposition tablet computer 110 similarly to how a user might reposition a traditional laptop computer. In addition, because dual-hinge suspension 102 positions tablet computer 110 towards the center of bottom side 100(B) of tablet computer case 100, relative to dual-hinge suspension 102, the center of gravity of tablet computer case 100 is more centralized relative to the edges of the case, and therefore stable, compared to conventional designs. FIGS. 5-6 illustrate how tablet computer case 100 may be closed.

FIG. 5 illustrates the tablet computer case of FIG. 4 during a first phase of closing, according to various embodiments of the invention. During the first phase of closing, hinge 202 closes and hinge 200 remains substantially stationary. As shown, a user may initiate closing of tablet computer case 100 by exerting a force 500 on the top surface of top side 100(A). Force 500 induces a torque 502 at hinge 202. Force 500 may also induce a torque at hinge 200. Importantly, the repulsion between magnet strips 216 and 232 may also prevent the bottom edge of tablet computer 110 from accidentally contacting bottom surface 100(B). In addition, magnetic attraction between magnet strips 216 and 224 promotes rotation at hinge 202. Once hinge 202 has closed until a mechanical limit is reached, and magnet strips 216 and 224 have drawn tablet computer 110 and top side 100(A) into the flush orientation shown via magnetic attraction between magnetic strips 216 and 224, hinge 200 may then engage during a second phase of closing, described below in conjunction with FIG. 6.

FIG. 6 illustrates the tablet computer case of FIG. 5 during a second phase of closing, according to various embodiments of the present invention. During the second phase of closing, hinge 200 engages to complete the closing of tablet computer case 100. As shown, with hinge 202 secured in a closed position, force 500 induces torque 602 at hinge 200. Torque 602 overcomes any repulsion between magnet strips 216 and 232 and any dampening caused by hinge 200. Accordingly, tablet computer case 100 is returned to a closed position, with both hinges stationed at respective mechanical limits.

Referring generally to FIGS. 2-6, persons skilled in the art will recognize that the particular geometry of dual-hinge suspension 102, in both dynamic and static operation, parallels the dynamic and static operation of a laptop computer. During opening, tablet computer case 100 has similar dynamics to a laptop computer. Once opened, tablet computer case 100 has similar balance characteristics to a laptop computer. However, unlike a laptop computer, tablet computer 110 can be decoupled from tablet computer case 100 and used as a traditional tablet computer. Further, because tablet computer case 100 positions the center of gravity towards the center of the case, without adjusting battery size, tablet computer 110 may have a comparable or longer battery life compared to a traditional laptop computer. Thus, the dual-hinge suspension 102 implemented in the tablet computer case 100 provides the benefits of both laptop computers and tablet computers, without several of the downsides.

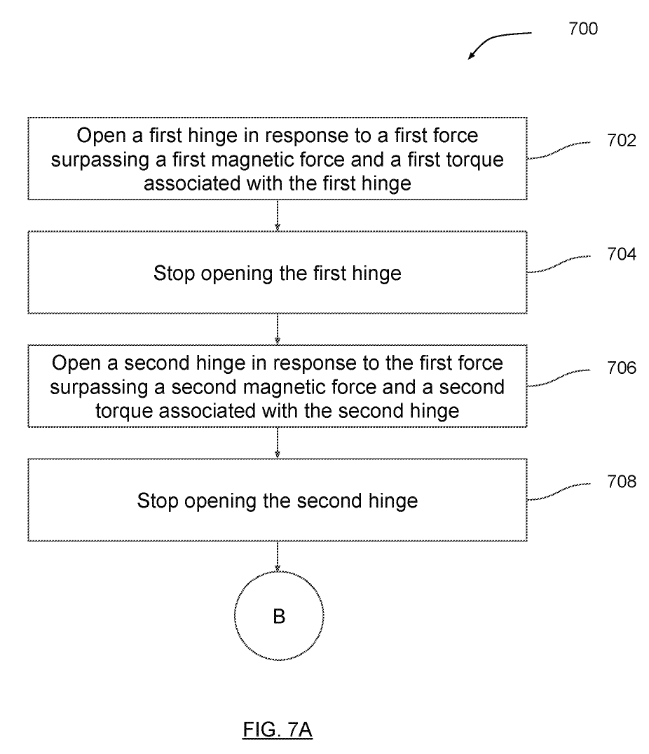

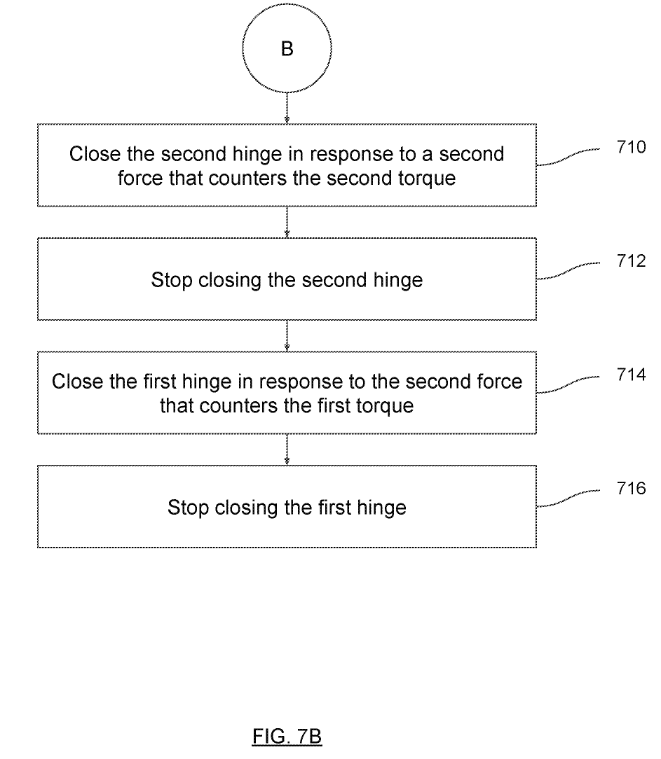

FIGS. 7A-7B illustrate a flow diagram of method steps for opening and closing a tablet computer case, according to various embodiments of the present invention. Although the method steps are described in conjunction with the systems of FIGS. 1-6, persons skilled in the art will understand that any system configured to perform the method steps, in any order, is within the scope of the present invention.

As shown in FIG. 7A, a method 700 begins at step 702, where hinge 200 opens in response to a first force exceeding a first magnetic force and a first torque associated with the first hinge. The first force could include, for example, force 300 shown in FIG. 3. The first force may be exerted when a user opens tablet computer case 100. The first magnetic force could include, for example, the attractive force between magnet strips 214 and 230. The first torque may include a dampening torque associated with hinge 200 and/or a spring torque associated with hinge 200. At step 704, hinge 200 stops opening upon reaching a maximum opening angle. The maximum opening angle generally corresponds to a mechanical limit associated with hinge 200.

At step 706, hinge 202 opens in response to the first force exceeding a second magnetic force and a second torque associated with the second hinge. The second magnetic force could include, for example, the attractive force between magnet strips 216 and 224. The second torque may include a dampening torque associated with hinge 202 and/or a spring torque associated with hinge 202. At step 706, hinge 202 stops opening upon reaching a maximum opening angle and tablet computer case 100 resides in an open position. The maximum opening angle generally corresponds to a mechanical limit associated with hinge 202. The user of tablet computer case 100 may perform various adjustments to reposition and/or reorient tablet computer 110 and may then close tablet computer case 100, as discussed below in conjunction with FIG. 7B.

As shown in FIG. 7B, the method 700 continues at step 710, where hinge 202 closes in response to a second force that counters the second torque. The second force could include, for example, force 500 shown in FIG. 5. The second force may be exerted when a user closes tablet computer case 100. As mentioned above, the second torque may include a dampening and/or spring torque associated with hinge 202. At step 712, hinge 202 stops closing upon reaching a maximum closing angle associated with a mechanical limit. At step 714, hinge 200 closes in response to the second force countering the first torque. Again, the first torque may include a dampening and/or spring torque associated with hinge 200. At step 716, hinge 200 reaches a mechanical limit associated with a maximum closing angle and stops closing. In one embodiment, magnet strips 216 and 232 are a safety backup solution configured to overcome the torque force of hinge 200 during operation of hinge 202. During that operation, the repulsive force of magnet strips 216 and 232 prevent the tablet from touching bottom surface 100(B) while enabling smooth adjustment of hinge 202.

In sum, a tablet computer and keyboard are coupled to a tablet computer case. The tablet computer case includes a dual-hinge suspension that allows the tablet computer case to open and close with similar mechanics as a laptop computer. In particular, the dual-hinge suspension includes two hinges that open and close sequentially in different phases. During a first phase of opening, the first hinge opens until a mechanical limit is reached while the second hinge remains stationary. In a second phase of opening, the first hinge is stationary while the second hinge opens until a mechanical limit is reached. During a first phase of closing, the second hinge closes until a mechanical limit is reached while the first hinge remains stationary. In a second phase of closing, the second hinge is stationary while the first hinge closes until a mechanical limit is reached.

At least one advantage of the disclosed technique is that the tablet computer case is capable of being placed on any type of surface, including the lap of a user, without inducing significant instability. In addition, the tablet computer case opens and closes in a simple notebook-like manner and includes a full keyboard and track pad, similar to a laptop computer. Importantly, however, unlike a laptop computer, the tablet computer case includes a tablet computer that may have substantially longer battery life than a conventional laptop computer. Also, the tablet computer within the tablet computer case can be removed and used as a conventional tablet computer, unlike a laptop computer.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present disclosure are described above with reference to flowchart illustrations and/or block diagrams of methods and apparatus (systems) according to embodiments of the disclosure. The flowchart and block diagrams in the figures illustrate the architecture, functionality, and operation of possible implementations of systems and methods according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware.

While the preceding is directed to embodiments of the present disclosure, other and further embodiments of the disclosure may be devised without departing from the basic scope thereof, and the scope thereof is determined by the claims that follow.

1. A tablet computer case, comprising:
a first surface configured to couple to a keyboard;
a second surface configured to couple to a tablet computer; and
a dual-hinge suspension coupled between the first surface and the second surface, comprising:
a first hinge coupled to the first surface, and
a second hinge coupled to the second surface, wherein the first hinge operates in response to a mechanical limit associated with the second hinge, and the second hinge operates in response to a mechanical limit associated with the first hinge.

2. The tablet computer case of claim 1, further comprising a first set of magnets disposed proximate to the second surface and configured to attract a second set of magnets included in the tablet computer.

3. The tablet computer case of claim 2, wherein, during opening of the tablet computer case, the first set of magnets is configured to magnetically attract the second set of magnets to prevent the second hinge from opening until the first hinge has reached the mechanical limit associated with the first hinge.

4. The tablet computer case of claim 1, further comprising a first set of magnets disposed proximate to the first surface and configured to repel a second set of magnets included in the tablet computer.

5. The tablet computer case of claim 4, wherein, during closing of the tablet computer case, the first set of magnets is configured to magnetically repel the second set of magnets to prevent the first hinge from closing until the second hinge has reached the mechanical limit associated with the second hinge.

6. The tablet computer case of claim 4, wherein, during closing of the tablet computer case, the first set of magnets is configured to magnetically repel the second set of magnets to prevent the tablet computer from contacting the first surface.

7. The tablet computer case of claim 1, further comprising a first set of magnets disposed proximate to the first surface and configured to attract a second set of magnets included in the keyboard.

8. The tablet computer case of claim 1, further comprising a first set of magnets disposed proximate to the first surface and configured to attract a second set of magnets disposed proximate to the second surface, wherein magnetic attraction between the first set of magnets and the second set of magnets causes the tablet computer case to remain closed.

9. The tablet computer case of claim 1, wherein the tablet computer is configured to perform input/output operations with the keyboard and provide power to the keyboard via the tablet computer case.

10. The tablet computer case of claim 1, wherein the keyboard is configured to perform input/output operations with the tablet computer and provide power to the tablet computer via the tablet computer case.

11. A method for positioning a tablet computer relative to a surface, the method comprising:
opening, in response to a first force, a first hinge that is coupled between a first surface and a second surface;
stopping the opening of the first hinge at a first angle that is acute with respect to the first surface;
opening, in response to the first force, a second hinge that is coupled between the first surface and the second surface; and
stopping the opening of the second hinge at a second angle that is obtuse with respect to the first surface,
wherein the positioning of the tablet computer is based on the first angle and the second angle.

12. The method of claim 11, wherein the first hinge opens in response to the first force surpassing a first magnetic force and a first torque associated with the first hinge.

13. The method of claim 11, wherein the second hinge opens in response to the first force surpassing a second magnetic force and a second torque associated with the second hinge.

14. The method of claim 11, wherein the first angle corresponds to a first mechanical limit associated with the first hinge and the second angle corresponds to a second mechanical limit associated with the second hinge.

15. The of claim 11, further comprising:
closing, in response to a second force countering the second torque, the second hinge;
stopping the closing of the second hinge at a third angle;
closing, in response to the second force countering the first torque, the first hinge; and
stopping the closing of the first hinge at a fourth angle, wherein the positioning of the tablet computer is based on the third angle and the fourth angle.

16. An apparatus coupled between a first surface and a second surface and comprising:
a first hinge coupled to the first surface and configured to:
open in response to a first force, and
stop opening at a first angle that corresponds to a first mechanical limit associated with the first hinge, wherein then first angle is an acute angle with respect to the first surface; and
a second hinge coupled to the second surface and configured to open in response to the first force, and
stop opening at a second angle that corresponds to a second mechanical limit associated with the second hinge, wherein the second angle is an obtuse angle with respect to the first surface.

17. The apparatus of claim 16, wherein the first hinge operates in response to the second mechanical limit and the second hinge operates in response to the first mechanical limit associated with the first hinge.

18. The apparatus of claim 16, wherein the first hinge operates based on a set of magnets associated with the second hinge that are configured to induce a first torque at the second hinge.

19. The apparatus of claim 16, wherein the second hinge operates based on a set of magnets associated with the second hinge that are configured to induce a first torque at the second hinge.

20. The apparatus of claim 16, wherein the first hinge is further configured to close in response to a second force and stop closing at a third angle that corresponds to a third mechanical limit associated with the first hinge, and wherein the second hinge is further configured to close in response to the second force and stop closing at a fourth angle that corresponds to a fourth mechanical limit associated with the first hinge.
